(19) United States
(12) Patent Application Publication
(10) Pub. No.: US 2015/0363096 A1
(43) Pub. Date: Dec. 17, 2015

(54) DEFINING A DESIGN PLAN

(71) Applicant: HEWLETT-PACKARD DEVELOPEMENT COMPANY, L.P., Houston, TX (US)

(72) Inventor: Christopher Michael Carlozzi, Sunnyvale, CA (US)

(73) Assignee: HEWLETT-PACKARD DEVELOPEMENT COMPANY, L.P., Houston, TX (US)

(21) Appl. No.: 14/761,550

(22) PCT Filed: Jan. 31, 2013
(86) PCT No.: PCT/US2013/024221

§ 371 Date: Jul. 16, 2015

(51) Int. Cl. G06F 3/0484; G06F 3/0482

(52) U.S. Cl. CPC G06F 3/04847; G06F 3/04842; G06F 3/0482

(57) ABSTRACT

A design plan can be defined as follows. In response to a user interaction with a user interface control for selecting from among a plurality of available nodes, a plurality of user selected nodes are caused to be displayed. Each node is displayed at a position on a virtual canvas determined by the user's interaction with the control. Each node is a visual representation of a plan element. The plan elements are examined to identify connection compatibilities between the elements. Based on the identified compatibilities and at least one of a user defined virtual canvas path and relative proximities between the nodes on the virtual canvas, the nodes are linked to create a plan artifact specifying corresponding connections between the represented plan elements.

### BACKGROUND

Defining a cloud or other computing model can be a complex experience that includes linking a variety of disparate services and components with nested functionalities and configurations into one working model. With multiple service providers and a varying set of connection types that need to be made, this process can require multiple of tools and variety of file manipulations.

### DRAWINGS

FIGS. 1-9 are example screen views of an example user interface for defining a design plan.

FIG. 10 depicts a system according to an example.

FIG. 11 is a block diagram depicting a memory resource and a processing resource according to an example.

FIG. 12 is a flow diagram depicting steps taken to implement an example.

### DETAILED DESCRIPTION

### Introduction

A design plan represents a system of components interconnected in such a way to achieves a desired result. A design plan can represent a various types of topologies, workflows, and architectures. An example design plan may represent a cloud architecture where the components can include infrastructure components such as servers, storage, and networking; platform components that sit on the infrastructure; application components that rely on the platform to execute; and service components that utilize application components to produce a desired function. In another example, a design plan can represent a topology of services, network elements, or other components. For a workflow, each component can represent a step in a process. Each such component can be represented by a generalized plan element. A plan element is electronic data that that identifies a given component, specifies default parameters for the component, and identifies that component's connection compatibilities. The compatibilities define a component or a component type that the represented component can or is allowed to connect to within a design plan.

A design plan can be defined through the creation of an artifact, referred to herein as a plan artifact. A plan artifact is electronic data representing a design plan that can be electronically processed to instantiate that design plan. The artifact, for example, may take any number of electronic forms inducing, but not limited to, data files, documents, scripts and executable modules. Where for example, a design plan represents a service topology; the plan artifact may be electronic data specifying the defined topology in a format compatible with a standard such as TOSCA (Topology and Orchestration Specification for Cloud Applications). Continuing with the cloud architecture example, a plan artifact may represent an infrastructure layer, a platform layer, an application layer, a service layer, or any combination thereof.

Various embodiments described below were developed for use in defining design plans. Embodiments allow users to interact with a virtual canvas to select a variety of nodes each representing a generalized plan element. The interaction opens an object-oriented interface menu allowing the user to select desired nodes and their placement on the virtual canvas. Interacting with the virtual canvas, users are able to modify parameters of the represented plan elements.

Further interactions link pairs of nodes which in turn define connections between corresponding pairs of plan elements. The decision as to which nodes are linked can be automated based on connection compatibilities of each represented plan element and the relative positioning of the nodes on the virtual canvas. Nodes positioned adjacent to one another are linked automatically so long as connecting the corresponding plan elements does not violate their connection compatibilities. The links can also be defined or modified based on a virtual canvas path defined by the user. For example, the user can swipe a path on the canvas that passes through a set of nodes. That set of nodes will be linked so long as connecting the corresponding plan elements does not violate a connection compatibility.

Links between each node are displayed visually on the virtual canvas. Each link represents a connection between corresponding plan elements. That connection is defined, at least in part, by one or more default parameters. Interacting with a given link, a user is able to modify those parameters. With the nodes, links and various parameters identified, the plan artifact can be saved. The artifact can be used and reused to instantiate a defined design plan.

The following description is broken into sections. The first, labeled “Illustrative Examples,” presents example screen views of a user interface used being used to define a design plan and create a corresponding plan artifact. The second section, labeled “Components,” describes examples of various physical and logical components for implementing various embodiments. The third section, labeled as “Operation,” describes steps taken to implement various embodiments.

### Illustrative Example

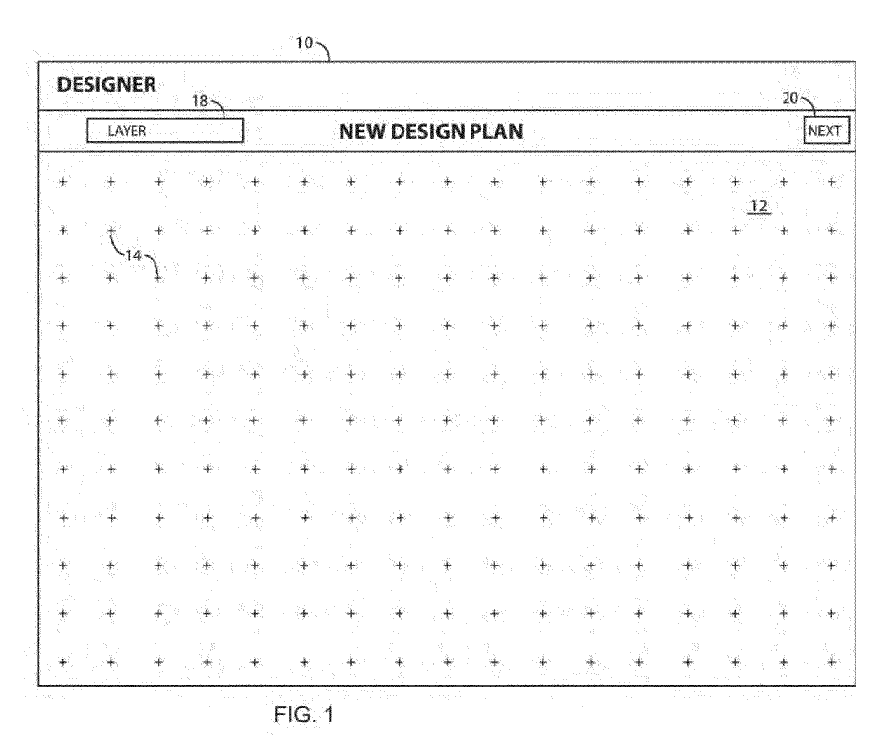

FIG. 1 depicts a screen view of graphical user interface (GUI) 10 for use in creating a design plan artifact. GUI 10 includes virtual canvas 12 which represents a surface for positioning user selected nodes representing various plan elements. In this example, virtual canvas 12 is shown to include grid 14 for use in aligning those nodes. Where a design plan includes a number of layers, control 18 is used to select a current layer. Control 20 is used to mover to a next step in the design process.

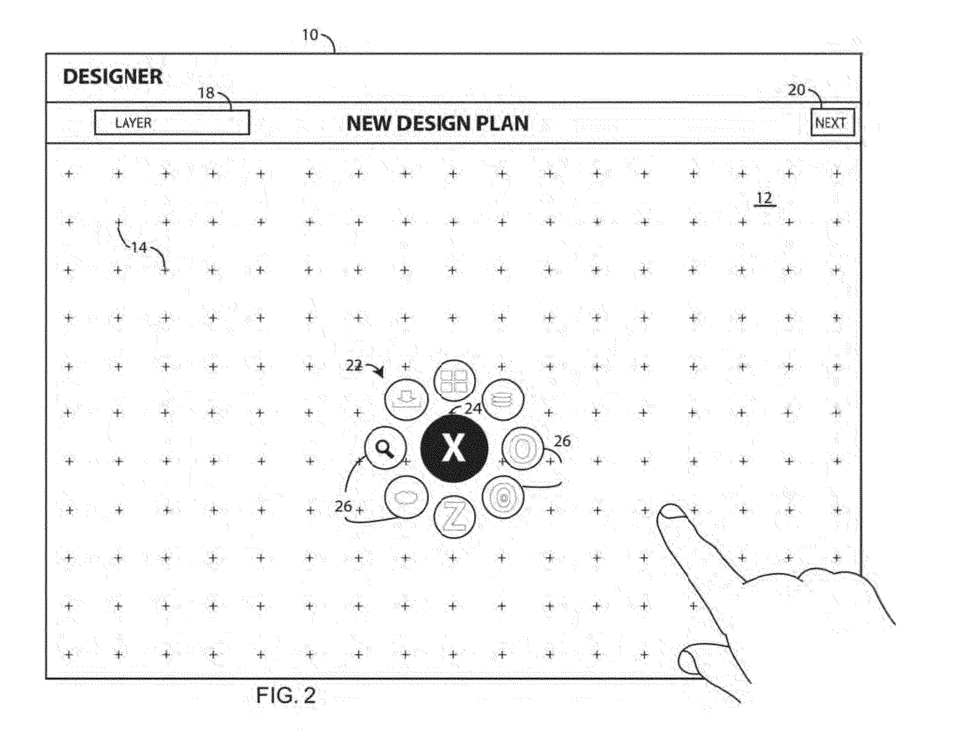

Moving to FIG. 2, a user has interacted with virtual canvas 12 causing the display of control 22. Control 22 in this example is a pinwheel control defined by a center point 24 surrounded by a plurality of node buttons 26. Each node button 26 represents an available node or a set of available nodes. A user interacts with a selected node button to select a desired node that will be placed on virtual canvas 12 positioned at center point 24. In this example, the user interacted with virtual canvas by tapping the screen on which GUI is displayed. In another example, the user may use an input device such as a mouse to click on the virtual canvas. In response to that interaction, control 22 appears with center point 24 positioned at the point of interaction with virtual canvas 12. In this fashion, the user selects the position for placing a selected node.

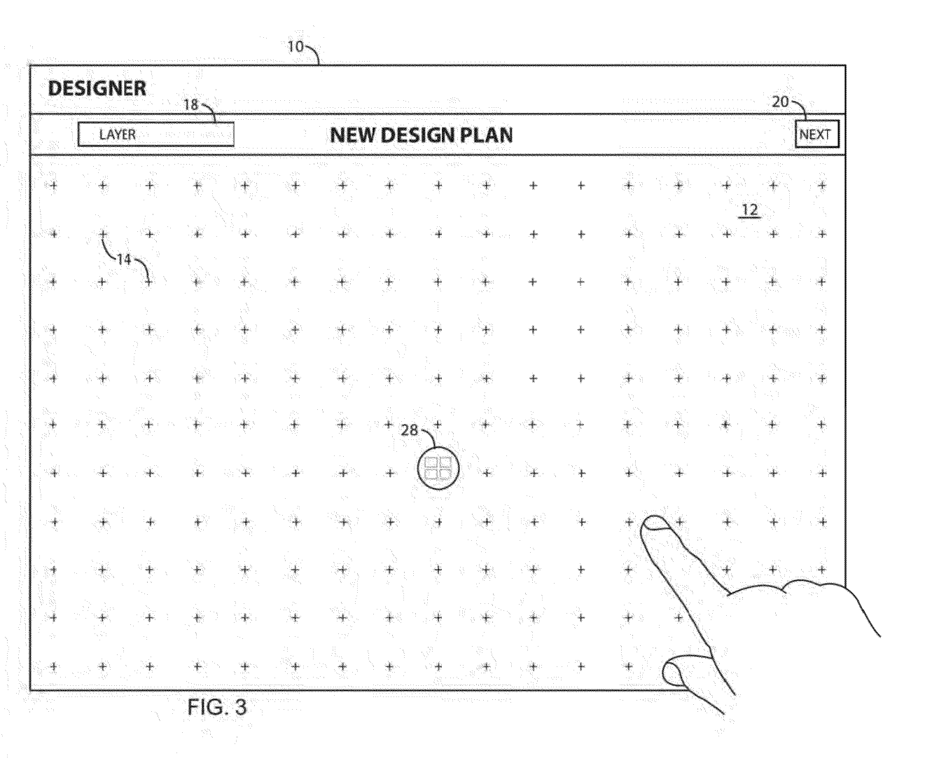

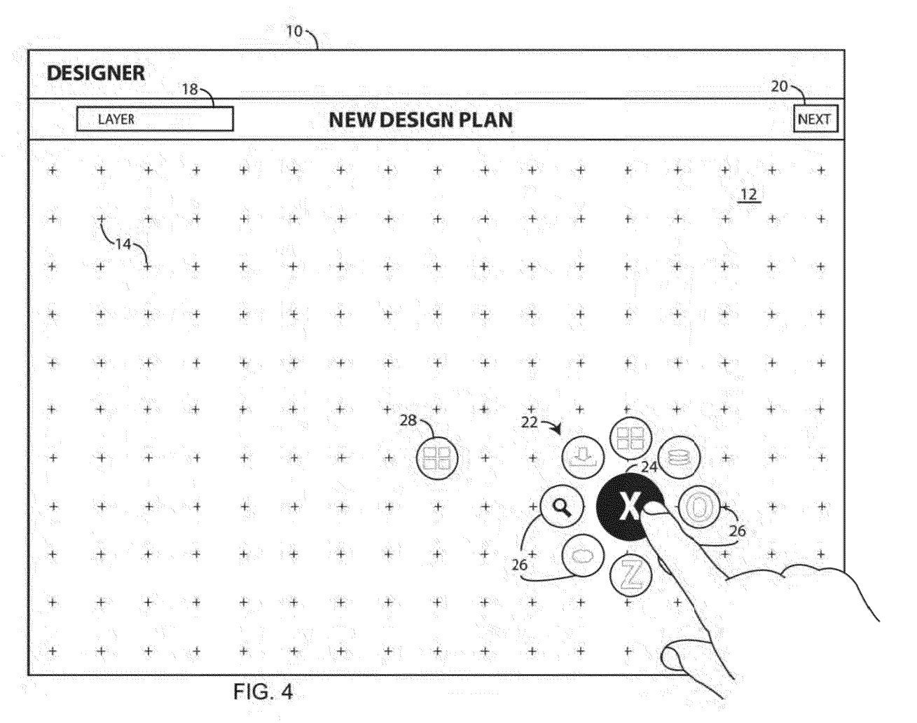

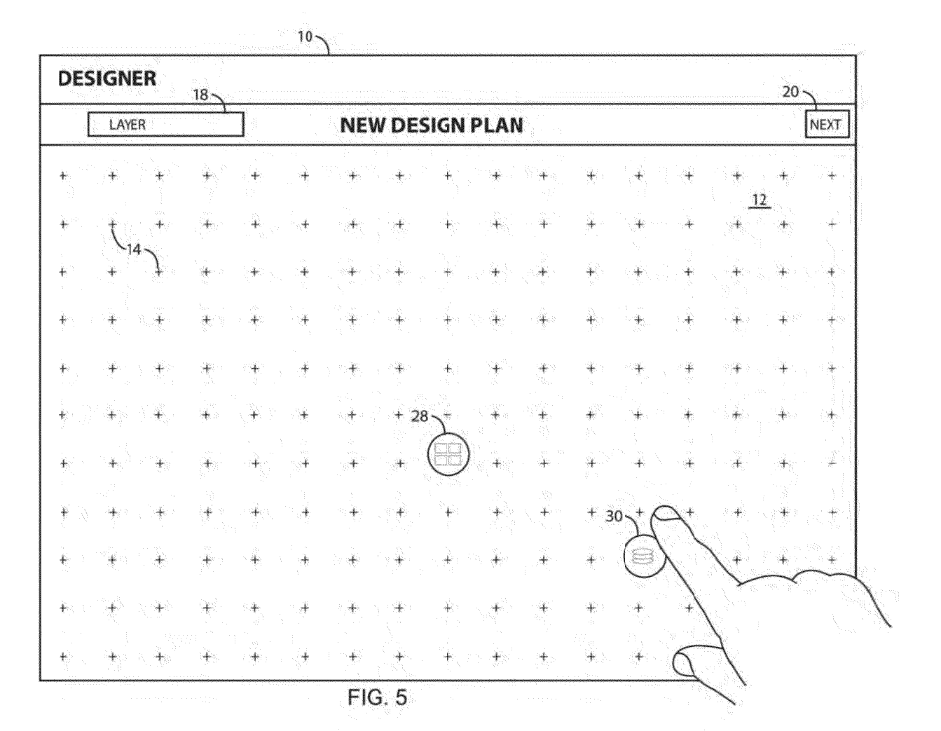

Looking at FIG. 3, a user has selected node 28 by interacting with a corresponding node button 26 shown in FIG. 2. Node 28 is positioned such that it effectively replaces center point 24 of control 22. In FIG. 4, the user again taps the screen displaying GUI 10 causing control 22 to reappear with center point 24 positioned at a position on virtual canvas 12 corresponding to the tap. Here, the user can again interact with a selected node button 26 to select a second node for use in defining the design plan. In FIG. 5, that node is node 30.

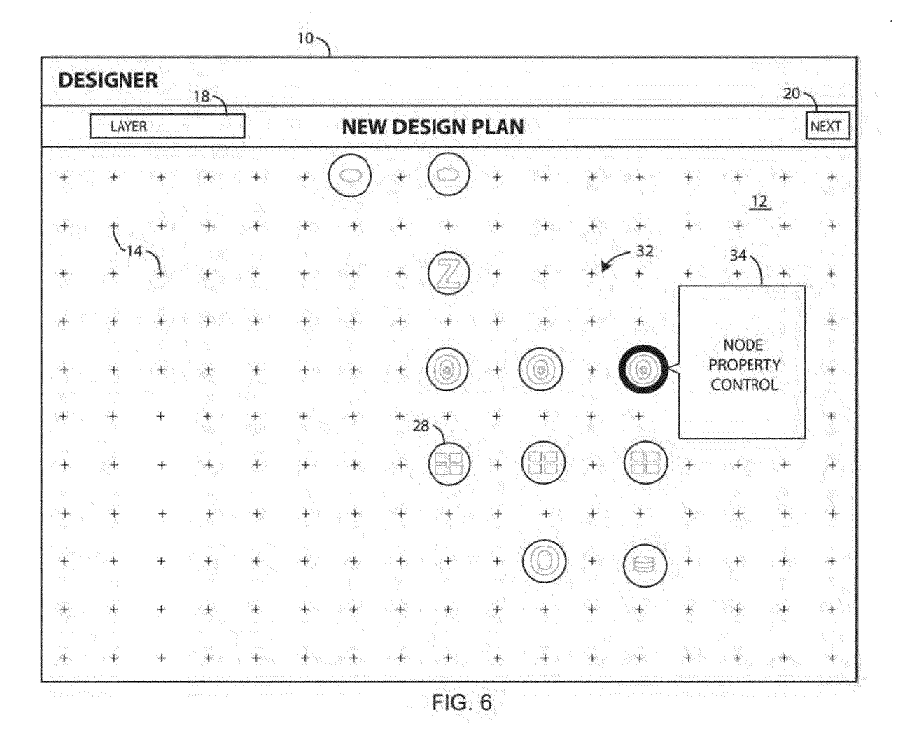

In FIG. 6, virtual canvas 12 has been populated with a plurality of selected nodes 32 positioned according to a user's interaction with virtual canvas 12. Each of the plurality of selected nodes 32, as mentioned, represents a corresponding plan element. In this example, each of the plurality of selected nodes 32 may be individually selected by a user allowing the user to modify one or more of the default parameters for a corresponding plan element. Here a user has selected a given node causing the display of control 34 through which the user can specify parameters for the represented element. Assuming, for the moment, that a desired number of nodes have been selected, the user can select control 20 which, in this example, causes links to be automatically established between the plurality of selected nodes 36.

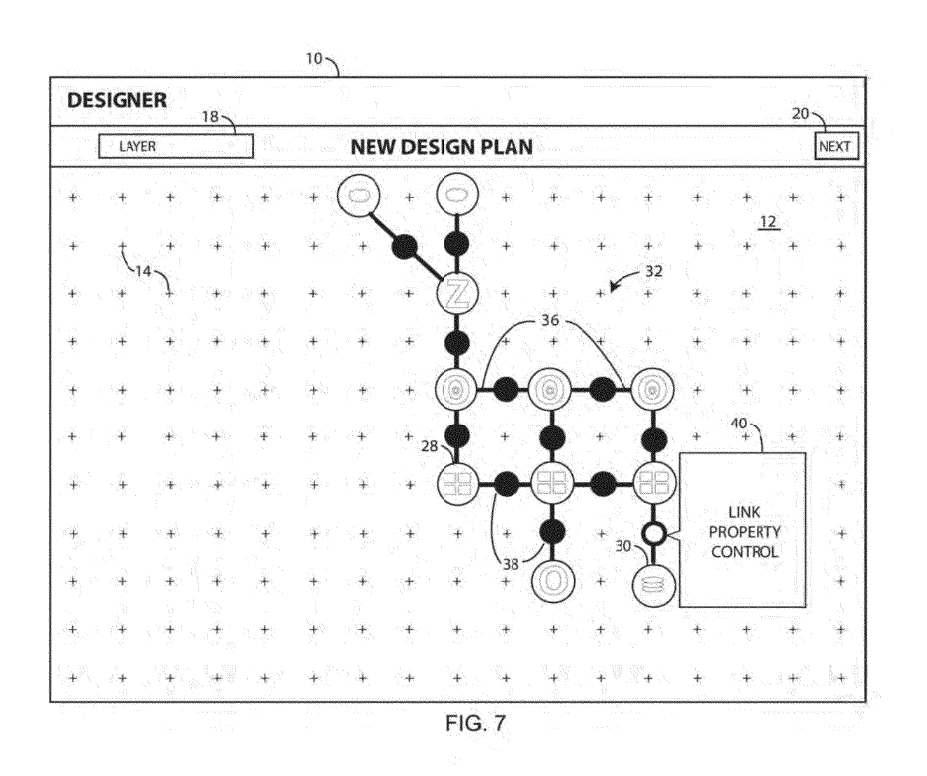

The established links 36 are depicted in FIG. 7. Each link 36 between a given pair of nodes represents connection between a corresponding pair of plan elements. In this example, the links are automatically generated based on connection compatibilities of the plan elements represented by the plurality of selected nodes 32 and the relative positions of the plurality of selected nodes 32 on virtual canvas 12. Here, adjacent nodes, as positioned on grid 14, are linked so long as the connection capabilities of the underlying plan elements are not violated. Each link 36 includes a flag 38 with which a user can interact. Interaction with a given flag 38 causes the display of a link property control 40 through which the user can specify parameters for a corresponding connection.

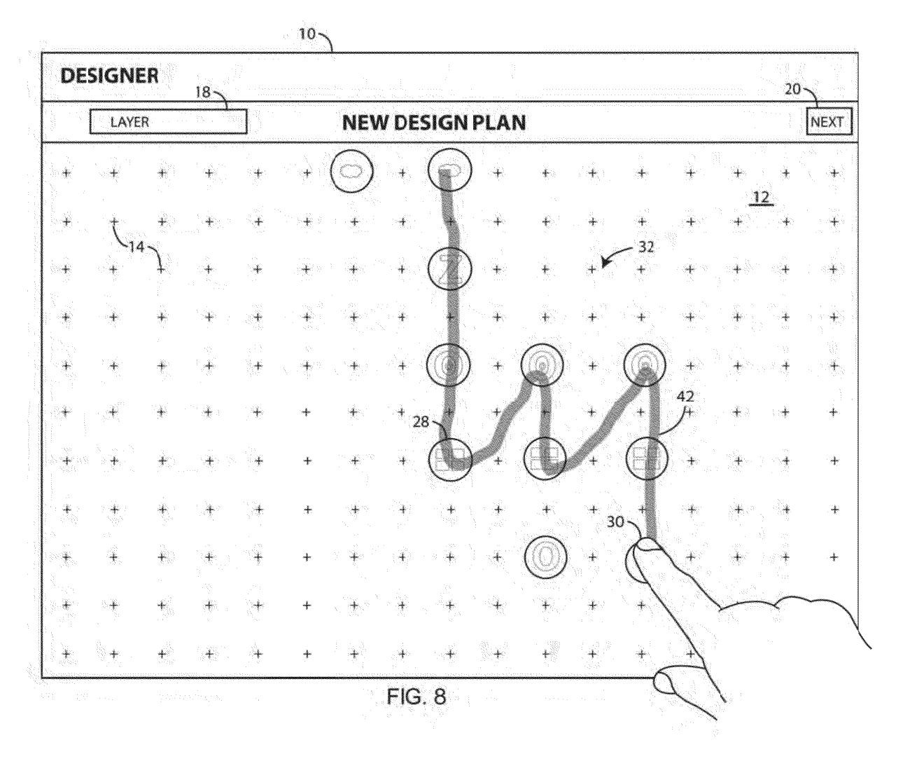

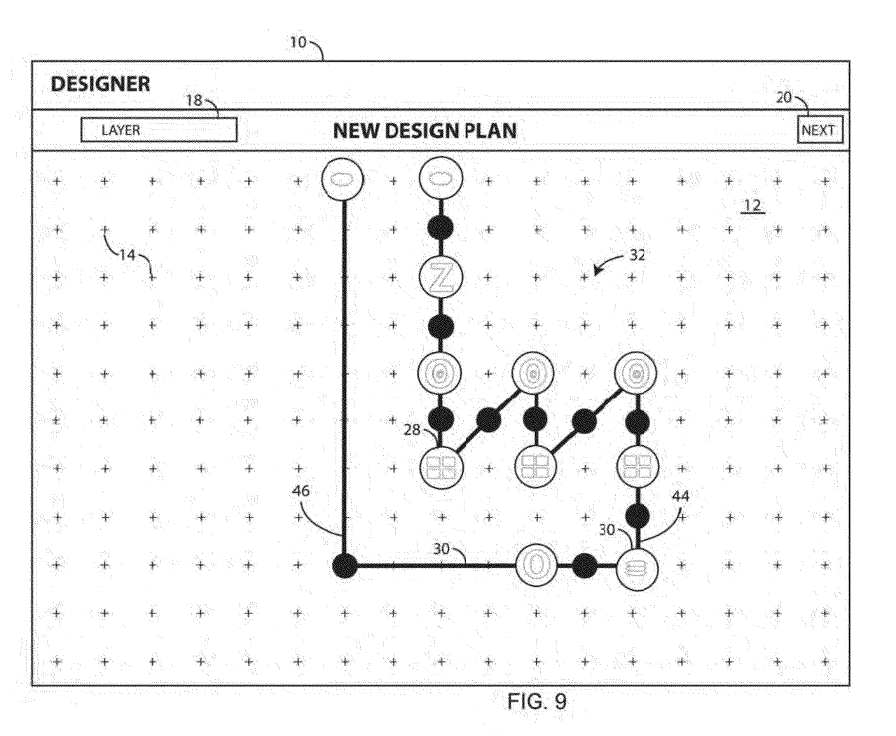

Moving to FIG. 8, the automatically selected links of FIG. 7 may not reflect the links desired by the user. In FIG. 8, the user has swiped a path 42 across virtual canvas 12. The virtual canvas path 42 passes through a user selected set of the plurality of nodes in a desired order. Based on that order and the connection compatibilities of the underlying plan elements, links are created between that set of nodes as depleted in FIG. 9.

Referring to FIG. 9, with the desired nodes and links placed on virtual canvas 12 and any desired node and link parameters set, the user can select control 20 to save a plan artifact defining the underlying plan elements and corresponding connections. Where for example the artifact represents a cloud architecture, the artifact can be used and reused to instantiate that cloud architecture using the components represented by the plan elements and connections represented by the various links between the user selected nodes 32.

### Components

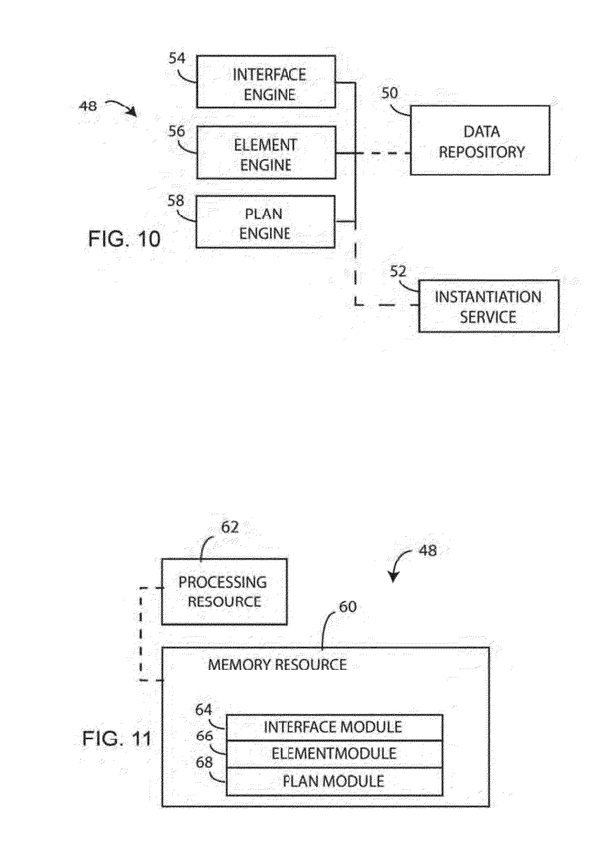

FIGS. 10 and 11 depict examples of physical and logical components for implementing various embodiments. In FIG. 10 various components are identified as engines 54-58. In describing engines 54-58, focus is on each engine's designated function. However, the term engine, as used herein, refers to a combination of hardware and programming configured to perform a designated function. As is illustrated later with respect to FIG. 11, the hardware of each engine, for example, may include a processor and a memory, while the programing is code stored on that memory and executable by the processor to perform the designated function. In another example, the hardware may be the memory used to store the code.

FIG. 10 depicts a system 48 for defining a plan artifact. System 48 is shown as being in communication with data repository 50 and instantiation service 52. Data repository 50 represents generally any memory for storing electronic data. Instantiation service 52 represents generally any combination of hardware and programming configured to process a plan artifact to instantiate the corresponding design plan.

System 48 includes interface engine 54, element engine 56, and plan engine 58. Interface engine 54 is configured to cause a display of a virtual canvas and a control for selecting from among a plurality of available nodes. The nodes may be nodes available to a particular user as defined by data in repository 50. In the example of FIGS. 1-9, virtual canvas 12 and control 22 are examples of a virtual canvas and control caused to be displayed by engine 54. In response to a user interaction with the control, interface engine 54 is responsible for causing a display of a plurality of user selected nodes positioned on the virtual canvas according to the user's interaction with the control. Plurality of selected nodes 32 depicted in FIG. 6-9 is an example.

Interface engine 54 may cause the display of the control upon detection of a user interaction with the virtual canvas at a particular position. For example, the user may touch the display at the position or, if using a mouse, click at that position. The control, in one example, is a pinwheel control having a plurality of node buttons positioned around the position touched or clicked. That position may be referred to as a center point for the control. The node buttons are for selecting from among the plurality of available nodes. Interface engine 54 is configured to cause a selected one of the plurality of nodes to be displayed at the center point according to a user interaction with one of the plurality of node buttons. Thus, after a number of iterations in which the user interacts with the virtual canvas causing the control to be displayed at various positions on that canvas, interface engine 54 causes the display of the plurality of the nodes selected by the user when interacting with the control at each position.

Element engine 56 is configured to examine plan elements associated the plurality of nodes to identify connection compatibilities between the plan elements. The plan elements may be stored in or otherwise identified by data stored in repository 50. For example each available node identified in repository 50 may also identify its corresponding plan element. In one example, each plan element defines its own connection compatibility, that is, it defines one or more plan element or element types with which it can connect. Connecting a plan element to another element that is not identified would violate the connection compatibility of the given element.

Plan engine 58 is configured to create a plan artifact specifying connections between the plan elements represented by the plurality of nodes. The connections are determined based on the connection compatibilities identified by element engine 56 and at least one of a user defined virtual canvas path and relative proximities of the plurality of user selected nodes as positioned on the virtual canvas. A virtual canvas path is a path over the virtual canvas that passes through two or more of the displayed nodes in a given order. Interface engine 54 may be responsible for identifying a user interaction with the virtual canvas that defines the virtual canvas path. For example, the user may swipe or click a path that passes through those nodes. Interface engine 54 may then identify the path as an ordered sequence of nodes such that the connections between plan elements may be defined at least in part by that sequence. FIGS. 8 and 9 illustrate an example.

Interface engine 54 may be responsible for linking the plurality of displayed nodes based on the connections determined by plan engine 58. Linking, in this example, can include causing a display of a link between each pair of nodes whose underlying plan elements have been connected by plan engine 58. Thus, linking those nodes can serve to create a plan artifact specifying corresponding connections between the represented plan elements.

Each displayed node may functions as a control that when selected allows a user to modify parameters associated with the plan element represented by that node. Further, each link joining a pair of nodes may serve as a control that when selected allows a user to modify parameters used to define the connection between a corresponding pair of plan elements. Plan engine 58 is then responsible for creating or modifying a plan artifact according to a user interaction with at least one of a node and a link displayed on the virtual canvas.

With the nodes and corresponding plan elements positioned and identified and the links and corresponding connections made, a design plan is defined and plan engine 58 is responsible for creating and saving a plan artifact representing the defined design plan. Plan engine 58 may save the artifact in repository 50.

Instantiation service 52 may then process that artifact to instantiate the defined design plan. Where the defined design plan is a cloud architecture, instantiation service 52 may be a cloud controller or other service capable is instantiating a cloud architecture using the artifact. Thus, each plan element represented by a displayed node in turn may represent at least one of an infrastructure element, a platform element, an application element, and a service element. The plan artifact is then configured to be processed to automatically instantiate at least one of an infrastructure component, platform component, application component, and service component.

In foregoing discussion, engines 54-58 were described as combinations of hardware and programming. Engines 54-58 may be implemented in a number of fashions. Looking at FIG. 11, the programming may be processor executable instructions stored on tangible memory resource 60 and the hardware may include processing resource 62 for executing those instructions. Thus memory resource 60 can be said to store program instructions that when executed by processing resource 62 implement system 48 of FIG. 10.

Memory resource 60 represents generally any number of memory components capable of storing instructions that can be executed by processing resource 62. Memory resource 60 is non-transitory in the sense that it does not encompass a transitory signal but instead is made up of more or more memory components configured to store the relevant instructions. Memory resource 60 may be implemented in a single device or distributed across devices. Likewise, processing resource 62 represents any number of processors capable of executing instructions stored by memory resource 60. Processing resource 62 may be integrated in a single device of distributed across devices. Further, memory resource 60 may be fully or partially integrated in the same device as processing resource 62, or it may be separate but accessible to that device and processing resource 62.

In one example, the program instructions can be part of an installation package that when installed can be executed by processing resource 62 to implement system 48. In this case, memory resource 60 may be a portable medium such as a CD, DVD, or flash drive or a memory maintained by a server from which the installation package can be downloaded and installed. In another example, the program instructions may be part of an application or applications already installed. Here, memory resource 60 can include integrated memory such as a hard drive, solid state drive, or the like.

In FIG. 11, the executable program instructions stored in memory resource 60 are depicted as interface module 64, element module 66, and plan module 68. Interface module 64 represents program instructions that when executed cause processing resource 62 to implement interface engine 54 of FIG. 10. Element module 66 represents program instructions that when executed cause the implementation of element engine 56. Likewise, plan module 68 represents program instructions that when executed cause the implementation of plan engine 58.

### Operation

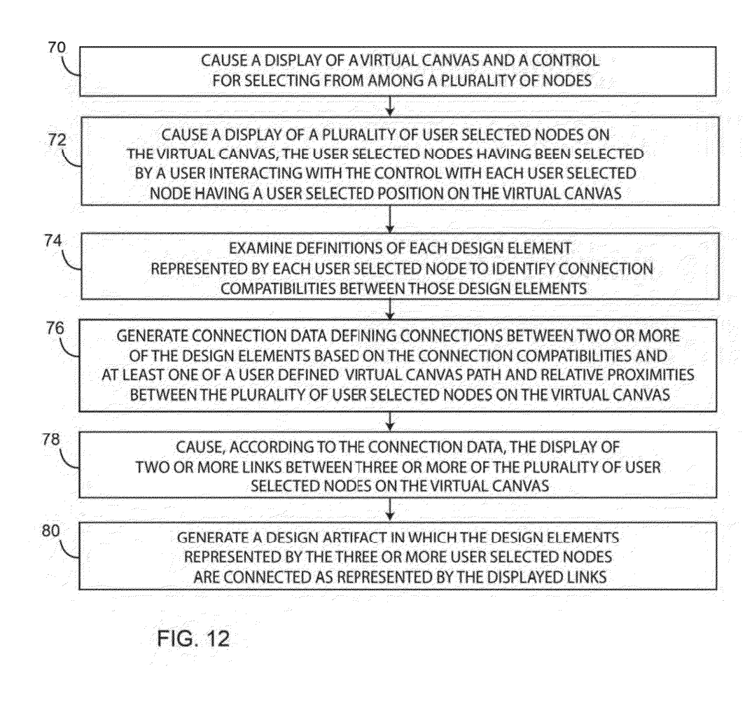

FIG. 12 is a flow diagram of steps taken to implement a method for creating a plan artifact. In discussing FIG. 12, reference may be made to the screen views of FIGS. 1-9 and the components depicted in FIGS. 10 and 11. Such reference is made to provide contextual examples and not to limit the manner in which the method depicted by FIG. 12 may be implemented.

Referring to FIG. 12, a virtual canvas and a control for selecting from among a plurality of nodes are caused to be displayed (step 70). The control may be displayed in response to user interactions with the virtual canvas. A plurality of user selected nodes is caused to be displayed on the virtual canvas (step 72). The user selected nodes are nodes having been selected by a user interacting with the control. Each user selected node has a user selected position on the virtual canvas. Referring to FIG. 10, interface engine 54 may be responsible for steps 70 and 72. Examples of a virtual canvas, a control, and the plurality of user selected nodes are depicted as canvas 12 and control 22, and nodes 32 FIGS. 1-9. Causing can include interacting directly with a display device or communicating data for use in directing the display device to display the virtual canvas, the control, and the plurality of user selected nodes.

Causing a display of a control in step 70 may include, for each of the plurality of user selected nodes, causing a display of a pin wheel interface control having a plurality of node buttons positioned around a corresponding center point having a position on the virtual canvas severed by the user. Causing a display of the plurality of user selected nodes in step 72 can then include, for each corresponding center point, causing a display of a corresponding node at that center point. The corresponding node is selected according to a user's interaction with one of the node buttons positioned around that center point.

The plan elements represented by the plurality of user selected nodes are examined to identify connection compatibilities between those plan elements (step 74). As explained above each node being displayed represents a plan element. Each plan element defines its own connection compatibilities with respect to other plan elements. Referring to FIG. 10, element engine 56 may be responsible for implementing step 74.

Connection data is generated (step 76). The connection data defines connections between two or more of the plan elements based on the connection compatibilities and at least one of a user defined virtual canvas path and relative proximities of the plurality of user selected nodes as positioned on the virtual canvas. The user defined virtual canvas path, for example, may be defined by a user interaction with the virtual canvas. That interaction defines a path that passes through two or more of the displayed nodes. The connection data may be used later to generate a plan artifact. The connection data may instead be part of such artifact being generated on the fly as nodes are added to the virtual canvas and connections are established. Referring to FIG. 10, plan engine 58 may be responsible for implementing step 76.

According to the connection data, two or more links are caused to be displayed between three or more of the plurality of user selected nodes on the virtual canvas (step 78). Referring to FIG. 10, interface engine 54 may implement step 80. Examples of such links are depicted as links 36 and 44 in FIGS. 1-9.

A plan artifact is generated in which the plan elements represented by the three or more user selected notes are connected as represented by the displayed links (step 80). Referring to FIG. 10, plan engine 58 may implement step 80. Where, for example, the design plan is a cloud architecture, each plan element represented by a displayed node in turn represents at least one of an infrastructure element, a platform element, an application element and a service element. Thus, step 80 may include generating a plan artifact that is configured to be processed to automatically instantiate at least one of an infrastructure component, platform component, application component, and service component.

In an example, each node caused to be displayed in step 72 functions as a control that when selected allows a user to modify parameters associated with the plan element represented by that node. Likewise, each link caused to be displayed in step 78 functions as a control that when selected allows a user to modify parameters used to define the connections between the plan elements represented by a corresponding pair of nodes. Step 80 can then include generating a plan artifact at least in part according to a user interaction with at least one of a node and a link.

### Conclusion

FIGS. 1-9 depict a user interface used to define a design plan. That user interface is an example only. FIGS. 10-11 aid in depicting the architecture, functionality, and operation of various embodiments. In particular, FIGS. 10 and 11 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 12 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A memory resource storing instructions that when executed cause a processing resource to:
in response to a user interaction with a user interface control for selecting from among a plurality of available nodes, cause a display of a plurality of user selected nodes each at a position on a virtual canvas determined by the user's interaction with the control, each node being a visual representation of a plan element;
examine plan elements to identify connection compatibilities between the elements;
based on the identified compatibilities and at least one of a user defined virtual canvas path and relative proximities between the nodes on the virtual canvas, link the nodes to create a plan artifact specifying corresponding connections between the represented plan elements.

2. The memory resource of claim 1, wherein the instructions when executed cause the processing resource to cause a display of the user interface control, the user interface control being a pin wheel interface control having a plurality of node buttons positioned around a center point, wherein the center point defines a position for placing a selected node on the virtual canvas, the selected node being a node associated with a user selected one of the node buttons.

3. The memory resource of claim 1, wherein:
the virtual canvas path is a path over the virtual canvas that passes through two or more of the displayed nodes, and
the instructions includes instructions that when executed cause a processing resource to identify a user interaction with the virtual canvas, the interaction defining the virtual canvas path.

4. The memory resource of claim 1, wherein:
each displayed node functions as a control that when selected allows a user to modify parameters associated with the plan element represented by that node;
the instructions include instructions that when executed cause the processing resource to cause a display of a link between each pair of connected nodes, each link serving as a control that when selected allows a user to modify parameters used to define the connections between the plan elements represented by a corresponding pair of connected nodes; and
the instructions include instructions that when executed cause the processing resource to modify the plan artifact according to a user interaction with at least one of a node and a link displayed on the virtual canvas.

5. The memory resource of claim 1, wherein the plan artifact represents a cloud architecture and wherein:
each plan element represented by a displayed node in turn represents at least one of an infrastructure element, a platform element, an application element and a service element; and
the plan artifact is configured to be processed to automatically instantiate at least one of an infrastructure component, platform component, application component, and service component.

6. A system, comprising a computer readable resource storing instructions that when executed causes a processing resource to implement an interface engine, an element engine, and a plan engine, wherein:
the interface engine is configured to cause a display of a virtual canvas and a control for selecting from among a plurality of available nodes, and in response to a user interaction with the control, cause a display of a plurality of user selected nodes positioned on the virtual canvas according to the user's interaction with the control;
the element engine is configured to examine architectural elements associated the plurality of nodes to identify connection compatibilities between the architectural elements;
the plan engine is configured to create a plan artifact specifying connections between the plan elements represented by the plurality of nodes, wherein the connections are determined based on the identified compatibilities and at least one of a user defined virtual canvas path and relative proximities of the plurality of user selected nodes as positioned on the virtual canvas.

7. The system of claim 8, wherein the interface engine, upon user interaction with the virtual canvas at user selected position, causes a display of the control for selecting from among a plurality of available nodes, the control including a plurality of node buttons positioned in a circular fashion around the position, the interface engine configured to cause a selected one of the plurality of nodes to be displayed at the position according to a user interaction with one of the plurality of node buttons.

8. The system of claim 6, wherein:
the virtual canvas path is a path over the virtual canvas that passes through two or more of the displayed nodes, and
the interface engine is configured to identify a user interaction with the virtual canvas, the interaction defining the virtual canvas path.

9. The system of claim 6, wherein:
each displayed node functions as a control that when selected allows a user to modify parameters associated with the plan element represented by that node;
the interface engine is configured to cause a display of a link between each pair of nodes that represent a pair of connected plan elements and each link serving as a control that when selected allows a user to modify parameters used to define the connection between a corresponding pair of plan elements; and
the plan engine is configured to modify the plan artifact according to a user interaction with at least one of a node and a link displayed on the virtual canvas.

10. The system of claim 6, further comprising the processing resource.

11. A method, comprising:
causing a display of a virtual canvas and a control for selecting from among a plurality of nodes;
causing a display of a plurality of user selected nodes on the virtual canvas, the user selected nodes having been selected by a user interacting with the control with each user selected node having a user selected position on the virtual canvas;
examining plan element represented by each of the plurality of user selected nodes to identify connection compatibilities between those plan elements;
generating connection data defining connections between two or more of the plan elements based on the connection compatibilities and at least one of a user defined virtual canvas path and relative proximities of the plurality of user selected nodes as positioned on the virtual canvas;
causing, according to the connection data, the display of two or more links between three or more of the plurality of user selected nodes on the virtual canvas; and
generating a plan artifact in which the plan elements represented by the three or more user selected notes are connected as represented by the displayed links.

12. The method of claim 11, wherein:
each plan element represented by a displayed node in turn represents at least one of an infrastructure element, a platform element, an application element and a service element; and
generating comprises generating a plan artifact that is configured to be processed to automatically instantiate at least one of an infrastructure component, platform component, application component, and service component.

13. The method of claim 11, wherein:
causing a display of a control comprises, for each of the plurality of user selected nodes, causing a display of a pin wheel interface control having a plurality of node buttons positioned around a corresponding center point having a position on the virtual canvas selected by the user;
causing a display of the plurality of user selected nodes comprises, for each corresponding center point, causing a display of a corresponding node at that center point, the corresponding node selected according to a user's interaction with one of the node buttons positioned around that center point.

14. The method of claim 11, comprising identifying a user interaction with the virtual canvas, the user interaction defining the interaction defining the virtual canvas path, the virtual canvas path passing through two or more of the displayed nodes.

15. The method of claim 11, wherein:
each displayed node functions as a control that when selected allows a user to modify parameters associated with the plan element represented by that node;
each displayed link functions as a control that when selected allows a user to modify parameters used to define the connections between the plan elements represented by a corresponding pair of nodes; and
generating comprises generating a plan artifact at least in part according to a user interaction with at least one of a node and a link.
